(19) United States
(12) Patent Application Publication
(10) Pub. No.: US 2022/0122749 A1
(43) Pub. Date: Apr. 21, 2022

(54) SUPERCONDUCTING WIRE JUMPERS FOR ELECTRICALLY CONDUCTIVE THERMAL BREAKS

(71) Applicant: International Business Machines Corporation, Armonk, NY (US)

(72) Inventor: Nicholas A. Masluk, Putnam Valley, NY (US)

(21) Appl. No.: 17/074,289

(22) Filed: Oct. 19, 2020

(51) Int. Cl. H01B 12/06; H01R 4/68; H01R 12/63; F17C 3/08

(52) U.S. Cl. CPC H01B 12/06; F17C 3/085; H01R 12/63; H01R 4/68

(57) ABSTRACT

Techniques facilitating electrical coupling within cryogenic environments are provided. In one example, an electrical coupling device for a cryogenic electronics system can comprise a flexible wiring strip that includes non-superconducting wiring and a thermal break that includes superconducting wiring. The superconducting wiring can be coupled with the flexible wiring strip to bridge a gap defined, in part, by the flexible wiring strip. The superconducting wiring comprises higher electrical conductivity and lower thermal conductivity than the non-superconducting wiring.

### BACKGROUND

The subject disclosure relates to cryogenic environments, and more specifically, to electrical coupling devices for cryogenic environments.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate electrical coupling within cryogenic environments are described.

According to an embodiment, an electrical coupling device for a cryogenic electronics system can comprise a flexible wiring strip that includes non-superconducting wiring and a thermal break that includes superconducting wiring with higher electrical conductivity and lower thermal conductivity than the non-superconducting wiring. The thermal break connects to the flexible wiring strip.

In an embodiment, the non-superconducting wiring can comprise copper. In an embodiment, the electrical coupling device can further comprise a coupler that couples the super-conducting wiring to the non-superconducting wiring. In an embodiment, the coupler comprises at least one of: a solder; a weld; a compressive connector; or a conductive epoxy. In an embodiment, the superconducting wiring can comprise Niobium Titanium (NbTi). In an embodiment, the electrical coupling device can further comprise a copper pad on the flexible wiring strip, coupled to the non-superconducting wiring to form a jumper. In an embodiment, the NbTi superconducting wiring can be soldered to the copper pad. In an embodiment, the soldering can comprise indium-based solder. In an embodiment, the electrical coupling device can further comprise an insulating varnish covering at least a portion of the jumper. In an embodiment, the insulating varnish can provide at least one of: insulation or mechanical support to the jumper. In an embodiment, the electrical coupling device can further comprise a Kapton tape covering at least a portion of the jumper. In an embodiment, the Kapton tape can provide at least one of: insulation or mechanical support to the jumper.

According to another embodiment, a cryogenic wiring structure can comprise a superconducting element that can be coupled to first and second non-superconducting elements via respective first and second endpoints. The respective first and second endpoints can define a gap between the first and second non-superconducting elements. The superconducting element can provide a thermal break in the cryogenic wiring structure.

In an embodiment, the first and second non-superconducting elements can form a circuit trace that propagates a direct current (DC) or low frequency signal within a cryogenic environment. In an embodiment, the superconducting element can comprise Niobium Titanium. In an embodiment, the first non-superconducting element can comprise copper. In an embodiment, the first non-superconducting element can comprise cupronickel, Inconel, Manganin, or phosphor bronze. In an embodiment, the gap can be located between different temperature stages of a cryostat. In an embodiment, the gap can be located within a cryogenic environment at a region having a temperature below 3.5 Kelvin. In an embodiment, the gap can be located within a cryogenic environment at a region having a temperature that is below a superconducting transition temperature of the superconducting element. In an embodiment, the superconducting element can be coupled to the first and second non-superconducting elements using ultrasonic soldering, welding, compressive connectors, conductive epoxy, or a combination thereof. In an embodiment, a pad can intervene between the first endpoint and the superconducting element. In an embodiment, the pad can comprise copper, a gold passivation layer, or a combination thereof.

According to another embodiment, a cryogenic wiring system can comprise a superconducting element, a first non-superconducting element coupled to the superconducting element via a first endpoint, and a second non-superconducting element coupled to the superconducting element via a second endpoint. The first and second endpoints can define a gap between the first and second non-superconducting elements. The superconducting element can provide a thermal break in the cryogenic wiring system. The superconducting element can comprise Niobium Titanium. The gap can be located between different temperature stages of a cryostat.

### DESCRIPTION OF THE DRAWINGS

FIG. 1 illustrates a top view of an example, non-limiting wiring structure that can facilitate electrical coupling within cryogenic environments, in accordance with one or more embodiments described herein.

FIG. 2 illustrates a top view of the example, non-limiting wiring structure of FIG. 1 after introducing gaps or discontinuities within the non-superconducting elements, in accordance with one or more embodiments described herein.

FIG. 3 illustrates a top view of the example, non-limiting wiring structure of FIG. 2 after forming thermal breaks using superconducting elements, in accordance with one or more embodiments described herein.

FIG. 4 illustrates a top view of another example, non-limiting cryogenic wiring structure comprising thermal breaks formed using superconducting elements, in accordance with one or more embodiments described herein.

FIG. 5 illustrates an isometric view of an example, non-limiting cryogenic environment, in accordance with one or more embodiments described herein.

FIG. 6 depicts a tension test performed on an example, non-limiting cryogenic wiring structure comprising a thermal break formed using a superconducting element, in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Cryogenic environments such as cryostats can utilize conducting elements or wires carrying direct current (DC) and low frequency signals for many applications, such as thermometry sensors, thermometry heaters, flux bias lines, piezoelectric actuators, mechanical relay solenoids, state monitor contacts, and the like. Such applications can generally involve wiring harnesses comprising bundles or weaves that include many individual wires or twisted pairs. The terms “wiring” and “conducting element” will be used interchangeably through the present disclosure unless context dictates otherwise.

Wires made of metals that are low in conductivity or superconduct can be used for lower temperature stages of cryostats where cooling capacity can be limited. Examples of such metals include: copper-nickel, phosphor bronze, MANGANIN (trademark name for a metal alloy of formula Cu₈₆Mn₁₂Ni₂ by Isabellenhüitte Heusler GmbH & Co. KG of Dillenburg, Germany), and the like. These wires can be installed individually, bundled, or weaved into a loom (such as the CRYOLOOM cryogenic woven loom available from Cambridge Magnetic Refrigeration Ltd. of Cambridge, England). Within such cryogenic environments, superconductor wiring can facilitate providing especially high electrical conductivity as well as low thermal conductivity.

One skilled in the art will appreciated that the costs of compact wiring for delivering power and low-frequency signals to lower temperature stages of cryogenic environments such as cryostats can be relatively high, in terms of material cost and assembly cost. For example, wiring that comprises individual varnished fine wires or looms soldered to high-density connectors can involve a time-consuming process to individually strip and solder the wires.

Flexible printed circuit panels can be used in cryogenic environments, either with copper or lower conductivity metals. Yet, superconducting metals are generally not available in printed circuit form. In some instances, aluminum may be available in printed circuit form. However, its use as a superconductor can be limited to temperatures below 1 Kelvin (K), such as exists within the still stage and below in a dilution refrigerator.

Copper wiring may be used down to temperatures of about 4 K for applications that involve wiring with minimal electrical resistance. Below temperatures of about 9 K, superconducting niobium titanium (NbTi) wiring can be used for its low electrical resistance and high thermal resistance properties. In applications where high resistance wiring is acceptable, wiring with restive metals can be utilized, such as wiring comprising phosphor-bronze, MANGANIN, and the like.

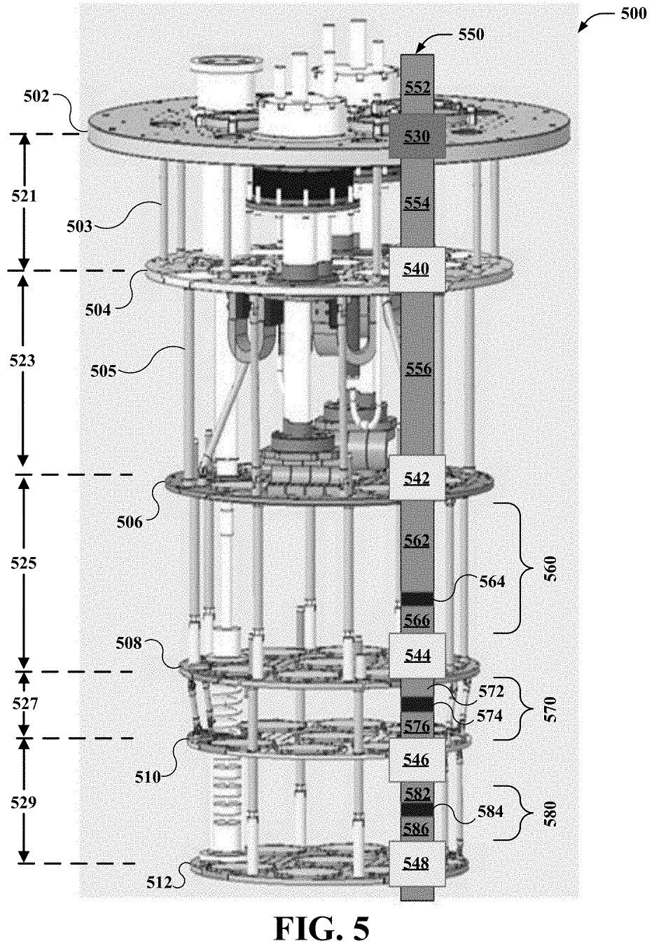

FIGS. 1-4 illustrate example, non-limiting multi-step fabrication sequences that can be implemented to fabricate one or more embodiments of the present disclosure described herein and/or illustrated in the figures. For example, the non-limiting multi-step fabrication sequence illustrated in FIGS. 1-4 can be implemented to fabricate cryogenic wiring structures for electrical coupling device 550 of FIG. 5.

FIG. 1 illustrates a top view of an example, non-limiting cryogenic wiring structure 100 that can facilitate electrical coupling within cryogenic environments, in accordance with one or more embodiments described herein. As shown in FIG. 1, wiring structure 100 can comprise one or more non-superconducting elements (e.g., non-superconducting element 120) attached to a substrate layer 110. Examples of materials suitable for implementing substrate layer 110 include: polymide, glass-reinforced epoxy laminate, metal core base material, and the like. Examples of materials suitable for implementing non-superconducting element 120 include: copper, phosphor-bronze, MANGANIN, cupronickel (CuNi), INCONEL (trademark name for a family of austenitic nickel-chromium-based superalloys by Special Metals Corp. of New Hartford, N.Y.), and the like.

In an embodiment, at least one non-superconducting element (e.g., non-superconducting element 120) of wiring structure 100 can be copper clad. In an embodiment, wiring structure 100 can comprise soldermask or coverlay overlaying the one or more non-superconducting elements and substrate layer 110. In an embodiment, the one or more non-superconducting elements can form a circuit trace that propagates a direct current (DC) or low frequency signal within a cryogenic environment. In an embodiment, wiring structure 100 comprises a printed circuit board. In an embodiment, wiring structure 100 comprises a flexible wiring strip.

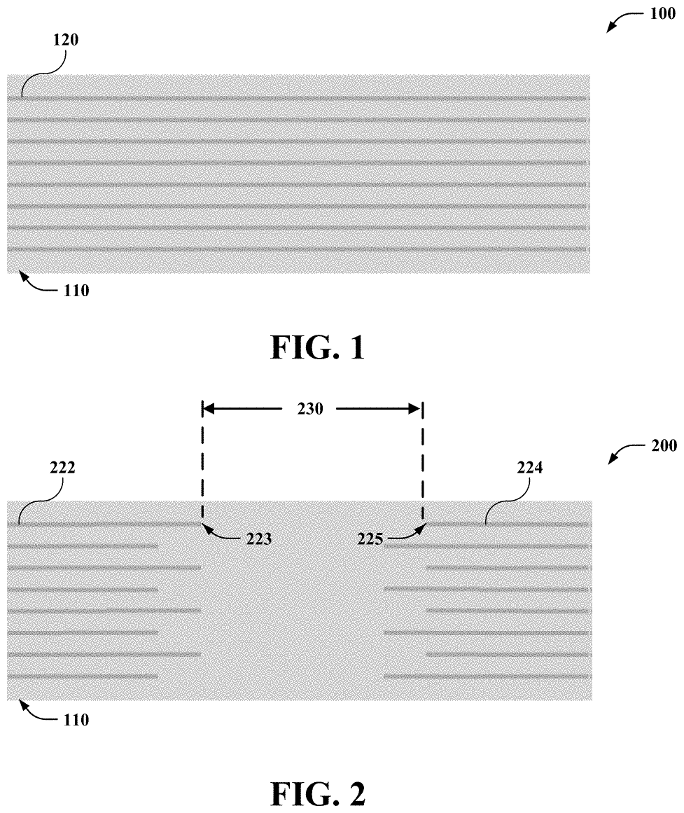

FIG. 2 illustrates a top view of the example, non-limiting cryogenic wiring structure 100 of FIG. 1 after introducing gaps or discontinuities within the non-superconducting elements, in accordance with one or more embodiments described herein. Cryogenic wiring structure 200 can comprise an example, non-limiting alternative embodiment of wiring structure 100 after removing portions of the non-superconducting elements attached to substrate layer 110. For example, a portion of non-superconducting element 120 can be removed from wiring structure 100 to form wiring structure 200, as illustrated in FIG. 2.

In this example, removing the portion of non-superconducting element 120 partitions non-superconducting element 120 into first non-superconducting element 222 and second non-superconducting element 224. As shown in FIG. 2, a first endpoint 223 of first non-superconducting element 222 and a second endpoint 225 of second non-superconducting element 224 defines a gap (or discontinuity) 230 between first non-superconducting element 222 and second non-superconducting element 224. In an embodiment, an etching process can be used to remove the portions of non-superconducting element 120. In an embodiment, the etching process used to move the portions of non-superconducting element 120 can be the same etching process used to form the one or more non-superconducting elements attached to substrate layer 110. Examples of suitable etching processes include: acid etching, laser ablation, mechanical milling, and the like. In an embodiment, at least, a portion of first non-superconducting element 222 proximate to first endpoint 223 and/or a portion of second non-superconducting element 224 proximate to first endpoint 225 can be copper plated.

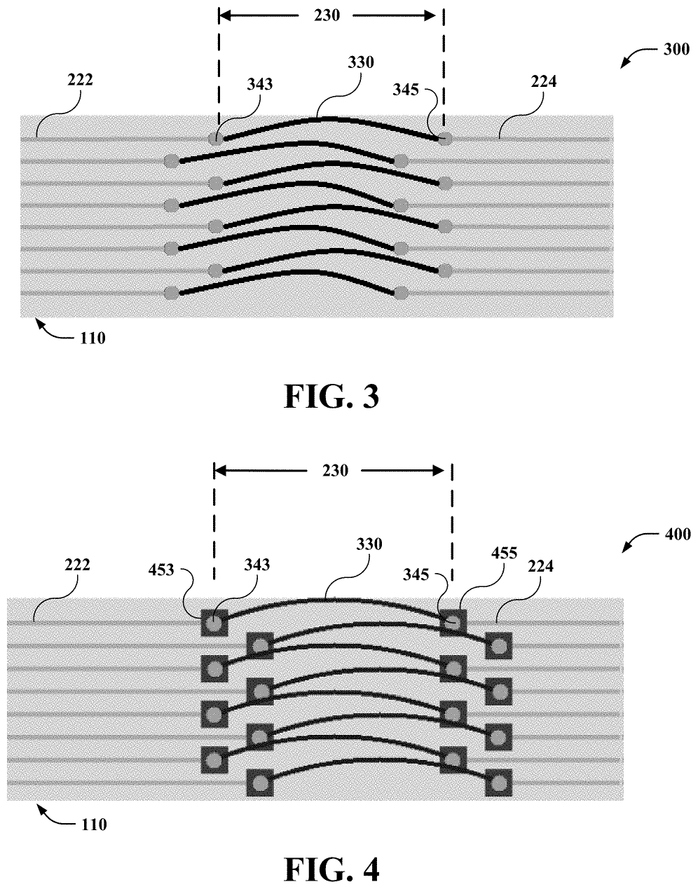

FIG. 3 illustrates a top view of the example, non-limiting cryogenic wiring structure 200 of FIG. 2 after forming thermal breaks using superconducting elements, in accordance with one or more embodiments described herein. Cryogenic wiring structure 300 can comprise an example, non-limiting alternative embodiment of wiring structure 200 after coupling superconducting elements with the non-superconducting elements to bridge the introduced gaps. For example, superconducting element 330 can be coupled to first non-superconducting element 222 and second non-superconducting element 224 of wiring structure 200 to form wiring structure 300, as illustrated in FIG. 3. Examples of materials suitable for implementing superconducting element 330 include: Niobium Titanium (NbTi), and the like. In an embodiment, superconducting element 330 comprises bare or uninsulated NbTi wire. In an embodiment, superconducting element 330 comprises higher electrical conductivity and lower thermal conductivity than first non-superconducting element 222 and/or second non-superconducting element 224.

In this example, superconducting element 330 is coupled to first non-superconducting element 222 via first endpoint 223 using coupler 343 and is also coupled to second non-superconducting element 224 via second endpoint 225 using coupler 345. FIG. 3 illustrates that coupling superconducting element 330 to first non-superconducting element 222 and second non-superconducting element 224 can bridge gap 230. Stated differently, coupling superconducting element 330 to first non-superconducting element 222 and second non-superconducting element 224 can form a jumper between first non-superconducting element 222 and second non-superconducting element 224. In bridging gap 230, superconducting element 330 provides a thermal break in wiring structure 300.

In an embodiment, superconducting element 330 is coupled to first non-superconducting element 222 and/or second non-superconducting element 224 using ultrasonic soldering, welding, compressive connectors conductive epoxy, or a combination thereof. In an embodiment, superconducting element 330 is coupled to first non-superconducting element 222 and/or second non-superconducting element 224 using an ultrasonic soldering iron without flux. In an embodiment, coupler 343 and/or coupler 345 comprises at least one of: a solder, a weld, a compressive connector, or a conductive epoxy. In an embodiment, the solder comprises indium-based solder. In an embodiment, coupling superconducting element 330 to first non-superconducting element 222 and/or second non-superconducting element 224 can include removing a portion of cladding from first non-superconducting element 222 and/or second non-superconducting element 224.

In an embodiment, wiring structure 300 further comprises an overlay 350 covering superconducting element 330. Examples of materials suitable for implementing overlay 350 include: insulating varnish, KAPTON tape (trademark name for a polyimide film by E. I. Du Pont De Nemours and Co. Corp. of Wilmington, Del.), and the like. In an embodiment, overlay 350 can be applied to superconducting element 330 after coupling superconducting element 330 to first non-superconducting element 222 and/or second non-superconducting element 224. In an embodiment, overlay 350 can provide superconducting element 330 with insulation, mechanical support, or a combination thereof.

FIG. 4 illustrates a top view of another example, non-limiting cryogenic wiring structure 400 comprising thermal breaks formed using superconducting elements, in accordance with one or more embodiments described herein. Cryogenic wiring structure 400 can comprise an example, non-limiting alternative embodiment of wiring structure 300 in which pads intervene between superconducting elements and non-superconducting elements. For example, pad 453 can intervene between an endpoint (e.g., endpoint 223 of FIG. 2) of first non-superconducting element 222 and superconducting element 330. As another example, pad 455 can intervene between an endpoint (e.g., endpoint 225 of FIG. 2) of second non-superconducting element 224 and superconducting element 330.

In an embodiment, pad 453 and/or pad 455 can be formed using an etching process. In an embodiment, the etching process that forms pad 453 and/or pad 455 can be the same etching process used to remove the portions of non-superconducting element 120. In an embodiment, the etching process that forms pad 453 and/or pad 455 can be the same etching process used to form the one or more non-superconducting elements attached to substrate layer 110. In an embodiment, pad 453 and/or pad 455 can comprise copper, a gold passivation layer, or a combination thereof. In an embodiment, the gold passivation layer can include: Electroless Nickel Immersion Gold (ENIG), Electroless Nickel Electroless Palladium Immersion Gold (ENEPIG), and the like.

FIG. 5 illustrates an isometric view of an example, non-limiting cryogenic environment 500, in accordance with one or more embodiments described herein. In FIG. 5, cryogenic environment 500 is depicted as a cryostat or dilution refrigerator with shielding cans removed. However, one skilled in the art will appreciate that embodiments of the present disclosure can be implemented in other cryogenic environments, such as cryogenic environments associated with magnetic resonance imaging systems, particle accelerators, and the like.

As shown in FIG. 5, cryogenic environment 500 comprises a plurality of temperature stages (or stages) that include: stage 502, stage 504, stage 506, stage 508, stage 510, and stage 512. Each stage among the plurality of stages can be associated with a different temperature. For example, stage 502 can be associated with a temperature of 300 K, stage 504 can be associated with a temperature of 45 K, stage 506 can be associated with a temperature of 3.5 K, stage 508 can be associated with a temperature of 800 millikelvin (mK), stage 510 can be associated with a temperature of 80 mK, and stage 512 can be associated with a temperature of 10 mK. Each stage of cryogenic environment 500 is spatially isolated from other stages of cryogenic environment 500 by a plurality of support rods (e.g., support rods 503 and 505).

Cryogenic environment 500 further comprises an electrical coupling device 550 that can facilitate propagation of electrical signals (e.g., DC or low frequency signals) within cryogenic environment 500. As shown in FIG. 5, electrical coupling device 550 includes cryogenic wiring structure 552 that can facilitate propagation of electrical signals between devices external to cryogenic environment 500 (e.g., a control panel) and cryogenic environment 500.

Electrical coupling device 550 further includes a plurality of cryogenic wiring structures that can each inter-stage propagation of electrical signals between adjacent stages of cryogenic environment 500. For example, the plurality of cryogenic wiring structures can include: wiring structure 554 that can facilitate inter-stage propagation of electrical signals between stage 502 and stage 504; wiring structure 556 that can facilitate inter-stage propagation of electrical signals between stage 504 and stage 506; wiring structure 560 that can facilitate inter-stage propagation of electrical signals between stage 506 and stage 508; wiring structure 570 that can facilitate inter-stage propagation of electrical signals between stage 508 and stage 510; and wiring structure 580 that can facilitate inter-stage propagation of electrical signals between stage 510 and stage 512.

As shown in FIG. 5, cryogenic environment 500 further comprises various interfaces that facilitate intra-stage propagation electrical signals within cryogenic environment. For example, such interfaces can include: hermetic feedthrough 530 that facilitates intra-stage propagation of electrical signals with respect to stage 502. Such interfaces can further include thermal clamps 540, 542, 544, 546, and 548 that facilitate intra-stage propagation of electrical signals with respect to stages 504, 506, 508, 510, and 512, respectively.

One skilled in the art will appreciate that inter-stage transfers of thermal energy within cryogenic environment 500 can occur via radiation or conduction. Example media that facilitate inter-stage transfers of thermal energy within cryogenic environment 500 via conduction can be the plurality of cryogenic wiring structures comprising electrical coupling device 550. In various embodiments of the present disclosure, techniques for mitigating such inter-stage transfers of thermal energy can vary based on temperatures associated with the different regions of cryogenic environment 500.

In an embodiment, thermal breaks can be implemented in electrical coupling device 550 using superconducting elements to mitigate such inter-stage transfers of thermal energy in regions of cryogenic environment 500 having temperatures that are below a threshold value. Such thermal breaks can facilitate providing electronical coupling device 500 with low thermal conductivity. In an embodiment, the threshold value is defined using a transition temperature associated with a superconducting element comprising a particular thermal break.

By way of example, wiring structure 560 includes wiring structure 562, thermal break 564, and wiring structure 566. In this example, thermal break 564 includes a superconducting element (e.g., superconducting element 330 of FIGS. 3-4) comprising Niobium Titanium with a transition temperature of about 9.2 K. FIG. 5 illustrates that wiring structure 560 is implemented in region 525 of cryogenic environment 500 that is defined by stages 506 and 508 that are associated with temperatures of 3.5 K and 800 mK, respectively. As such, thermal break 564 of wiring structure 560 is implemented to mitigate inter-stage transfers of thermal energy in a region of cryogenic environment 500 having temperatures that are below the 9.2 K transition temperature of Niobium Titanium.

Wiring structures 562 and 566 each comprise a non-superconducting element (e.g., non-superconducting element 120 of FIG. 1 or non-superconducting elements 222 and 224 of FIGS. 2-4). Forming thermal break 564 thereby involves coupling the superconducting element of thermal break 564 with the non-superconducting element of wiring structure 562 and the non-superconducting element of wiring structure 566, as discussed above with respect to FIGS. 3-4.

Regions 527 and 529 of cryogenic environment 500 each have temperatures that are below the 9.2 K transition temperature of Niobium Titanium. Accordingly, thermal breaks 574 and 584 with superconducting elements that comprise Niobium Titanium can be implemented to mitigate inter-stage transfers of thermal energy in regions 527 and 529. To that end, thermal break 574 of wiring structure 570 can be formed by coupling one or more superconducting elements of thermal break 574 with respective non-superconducting elements of wiring structures 572 and 576. Likewise, thermal break 584 of wiring structure 580 can be formed by coupling one or more superconducting elements of thermal break 584 with respective non-superconducting elements of wiring structures 582 and 586. In an embodiment, wiring structures 560, 570, and/or 580 can be implemented using wiring structures 300 and/or 400 of FIGS. 3-4, respectively.

In an embodiment, dimensions of non-superconducting elements can be varied to mitigate inter-stage transfers of thermal energy in regions of cryogenic environment 500 having temperatures that exceed a threshold value. By way of example, region 521 of cryogenic environment 500 is defined by stages 502 and 504 that are associated with temperatures of 300 K and 45 K, respectively. In this example, the threshold value is defined by the 9.2 K transition temperature of Niobium Titanium. Accordingly, wiring structure 554 is implemented in a region of cryogenic environment 500 having temperatures that exceed the threshold value. To mitigate inter-stage transfers of thermal energy in region 521, dimensions of non-superconducting elements (e.g., non-superconducting element 120 of FIG. 1 or non-superconducting elements 222 and 224 of FIGS. 2-4) comprising wiring structure 554 can be varied. In an embodiment, a width of, at least, one of the non-superconducting elements comprising wiring structure 554 can be reduced to mitigate inter-stage transfers of thermal energy. For example, the width of the at least one of the non-superconducting elements comprising wiring structure 554 can be reduced to approximately 100 microns wide with a thickness of 8.5 microns. In an embodiment, a length of, at least, one the non-superconducting elements comprising wiring structure 554 can be increased to mitigate inter-stage transfers of thermal energy. For example, the length of the at least one of the non-superconducting elements comprising wiring structure 554 can be increased to, at least, 20 centimeters.

In an embodiment, wiring structures with non-superconducting elements comprising resistive metals (e.g., CuNi, INCONEL, MANGANIN, phosphor bronze, and the like) can be implemented to mitigate inter-stage transfers of thermal energy in regions of cryogenic environment 500 having temperatures that exceed a threshold value. By way of example, region 523 of cryogenic environment 500 is defined by stages 504 and 506 that are associated with temperatures of 45 K and 3.5 K, respectively. In this example, the threshold value is defined by the 9.2 K transition temperature of Niobium Titanium. Accordingly, wiring structure 556 is implemented in a region of cryogenic environment 500 having temperatures that exceed the threshold value. To mitigate inter-stage transfers of thermal energy in region 523, wiring structure 556 is implemented with non-superconducting elements comprising resistive metals.

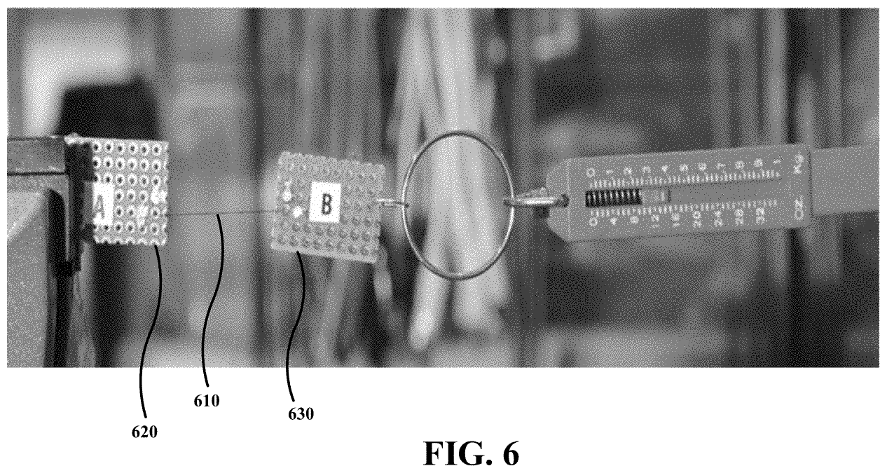

FIG. 6 depicts a tension test performed on an example, non-limiting cryogenic wiring structure comprising a thermal break formed using a superconducting element, in accordance with one or more embodiments described herein. In FIG. 6, the example cryogenic wiring structure includes a superconducting element 610 comprising Niobium Titanium. Superconducting element 610 is coupled to first wiring structure 620 and second wiring structure 630 via respective copper pads using an ultrasonic soldering iron and indium-based solder. Coupling between superconducting element 610 and first wiring structure 620 failed when the tensile test applied 400 grams of tensile force.

Embodiments of the present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

What has been described above includes mere examples of systems, devices, and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While certain example embodiments have been described, these embodiments have been presented by way of example only, and are not intended to limit the scope the disclosures herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the disclosures herein. The accompanying claims and their equivalents are intended to cover such forms or modifications as would fall within the scope and spirit of certain of the disclosures herein.

What is claimed is:

1. An electrical coupling device for a cryogenic electronics system, comprising:
a flexible wiring strip, comprising non-superconducting wiring; and
a thermal break comprising superconducting wiring coupled with the flexible wiring strip to bridge a gap defined, in part, by the flexible wiring strip, wherein the superconducting wiring comprises higher electrical conductivity and lower thermal conductivity than the non-superconducting wiring.

2. The device of claim 1, wherein the non-superconducting wiring comprises copper.

3. The device of claim 1, further comprising a coupler that couples the super-conducting wiring to the non-superconducting wiring.

4. The device of claim 3, wherein the coupler comprises at least one of: a solder; a weld; a compressive connector; or a conductive epoxy.

5. The device of claim 1, wherein the superconducting wiring comprises Niobium Titanium (NbTi).

6. The device of claim 5, further comprising a copper pad on the strip, coupled to the non-superconducting wiring to form a jumper, wherein the NbTi superconducting wiring is soldered to the copper pad.

7. The device of claim 6, wherein the soldering comprises indium-based solder.

8. The device of claim 6, further comprising an insulating varnish covering at least a portion of the jumper, wherein the insulating varnish provides at least one of: insulation or mechanical support to the jumper.

9. The device of claim 6, further comprising a Kapton tape covering at least a portion of the jumper, wherein the Kapton tape provides at least one of: insulation or mechanical support to the jumper.

10. A cryogenic wiring structure, comprising:
a superconducting element that is coupled to first and second non-superconducting elements via respective first and second endpoints that define a gap between the first and second non-superconducting elements, wherein the superconducting element provides a thermal break in the cryogenic wiring structure.

11. The cryogenic wiring structure of claim 10, wherein the first and second non-superconducting elements form a circuit trace that propagates a direct current (DC) or low frequency signal within a cryogenic environment.

12. The cryogenic wiring structure of claim 10, wherein the superconducting element comprises Niobium Titanium.

13. The cryogenic wiring structure of claim 10, wherein the first non-superconducting element comprises copper.

14. The cryogenic wiring structure of claim 10, wherein the first non-superconducting element comprises cupronickel, Inconel, Manganin, or phosphor bronze.

15. The cryogenic wiring structure of claim 10, wherein the gap is located between different temperature stages of a cryostat.

16. The cryogenic wiring structure of claim 10, wherein the gap is located within a cryogenic environment at a region having a temperature below 9 Kelvin.

17. The cryogenic wiring structure of claim 10, wherein the gap is located within a cryogenic environment at a region having a temperature that is below a superconducting transition temperature of the superconducting element.

18. The cryogenic wiring structure of claim 10, wherein the superconducting element is coupled to the first and second non-superconducting elements using ultrasonic soldering, welding, compressive connectors, conductive epoxy, or a combination thereof.

19. The cryogenic wiring structure of claim 10, wherein a pad intervenes between the first endpoint and the superconducting element, and wherein the pad comprises copper, a gold passivation layer, or a combination thereof.

20. A cryogenic wiring system, comprising:
a superconducting element;
a first non-superconducting element coupled to the superconducting element via a first endpoint; and
a second non-superconducting element coupled to the superconducting element via a second endpoint, wherein the first and second endpoints define a gap between the first and second non-superconducting elements, wherein the superconducting element provides a thermal break in the cryogenic wiring system,
wherein the superconducting element comprises Niobium Titanium, and the gap is located between different temperature stages of a cryostat.
